(19) United States
(12) Patent Application Publication
(10) Pub. No.: US 2026/0105559 A1
(43) Pub. Date: Apr. 16, 2026

(54) UTILIZING FORECASTING AND OPTIMIZATION MODELS TO GENERATE DYNAMIC PROVIDER DEVICE USER INTERFACES WITH FUTURE TRANSPORTATION VALUE MODIFIERS TO IMPROVE DEVICE NETWORK IMBALANCES

(71) Applicant: Lyft, Inc., San Francisco, CA (US)

(72) Inventors: Patricio Tomas Foncea Araneda, Boston, MA (US); Vijay Tupil Narasiman, San Francisco, CA (US); David Halsted Riege, San Francisco, CA (US); William Atlee Schultz, Austin, TX (US); Wilson James Turner, Dedham, MA (US); Pranav Ramchandra Chiplunkar, Fremont, CA (US); Nicolas Antonio Magana, Los Angeles, CA (US); Huan Cao, Foster City, CA (US); Hao Yi Ong, San Francisco, CA (US)

(21) Appl. No.: 18/916,463

(22) Filed: Oct. 15, 2024

(51) Int. Cl. G06Q 50/47; G06Q 10/0631; G06Q 30/0207

(52) U.S. Cl. CPC G06Q 50/47; G06Q 10/06315; G06Q 30/0223

(57) ABSTRACT

The present disclosure relates to systems, non-transitory computer-readable media, and methods for generating a forecasted transportation value schedule. In particular, in one or more embodiments, the disclosed systems can generate a plurality of transportation value modifiers for a plurality of time periods by assigning a consolidated transportation value for a plurality of provider devices based on predicted requestor devices, predicted provider devices, and provider device elasticity metrics for the plurality of time periods. In some cases, the disclosed systems can provide for display on a requestor device, a forecasted transportation value schedule that includes the transportation value modifiers and time periods. Based on detecting an initiation of a transportation service by the provider device, the disclosed systems can provide for display on the provider device a transportation value increase element based on a transportation modifier corresponding to the time period.

### BACKGROUND

Recent years have seen significant developments in on-demand transportation systems that utilize mobile devices to coordinate across computer networks. Indeed, the proliferation of web and mobile applications has enabled requesting devices to utilize on-demand ride-sharing systems to identify matches between provider devices and requestor devices and coordinate across computer networks to initiate transportation from one geographic location to another. For instance, conventional transportation network systems can determine the geographic locations of provider devices and requestor devices, generate digital matches between provider devices and requestor devices, and further track, analyze, and manage pick-up, transportation, and drop-off routines through digital transmissions across computer networks. Although on-demand transportation matching systems can identify requestor devices, select provider devices, dispatch provider devices, and dynamically match requestor devices and provider devices, such systems suffer from a number of technical problems, particularly in the efficiency and precision of implementing computer systems.

For example, conventional systems suffer from efficiency problems resulting from device imbalances across a computer-implemented network of mobile devices. For example, some existing systems face network inefficiencies during periods of device imbalances when there are not enough provider devices to align with requestor devices. This can lead to significant network inefficiencies, including increases in bandwidth consumption, time, and multiplied communications between servers and mobile devices on a per transportation request basis. For example, during imbalanced periods with insufficient provider devices, requestor devices will submit duplicative transportation requests, restart a mobile application, change a mobile application to an offline status and switch the mobile application back to online status, or navigate to a separate application or website altogether.

Indeed, conventional systems can iteratively repeat these respective processes before a requestor device or provider device accepts a transportation match. This not only wastes computer resources of the respective requestor or provider device, but backend servers utilize significant computer resources in iteratively managing transportation matches, processing duplicative requests, and reassigning requests across multiple requestor and provider devices. Accordingly, conventional systems suffer from inefficient utilization of computing resources (e.g., memory and processing power), excessive bandwidth utilization, and increased latency.

Relatedly, many transportation systems address device balance fluctuations by transmitting digital notifications to mobile devices in real-time regarding changed network conditions. However, this approach presents a number of technical problems. For example, responding to device imbalance fluctuations with digital notifications (such as invitations to switch to an online mode or real-time fluctuations in transportation value notifications) often fails to address the device imbalances. Furthermore, such notifications often leads to application unpredictability, which causes provider devices to navigate to other applications or websites to identify other alternative transportation networks. Accordingly, these conventional systems lack the ability to accurately and efficiently respond to fluctuations in network device imbalances in operating a transportation network.

These along with additional problems and issues exist with regard to conventional transportation matching systems.

### BRIEF SUMMARY

This disclosure describes one or more embodiments of methods, non-transitory computer-readable media, and systems for utilizing forecasting and optimization models to generate dynamic provider device user interfaces with future transportation value modifiers to improve device network imbalances across a transportation network. In one or more embodiments, the disclosed systems can utilize forecasting models to determine a number of predicted requestor devices, a number of predicted provider devices, and provider device elasticity metrics for future time periods. Based on the predicted requestor devices, predicted provider devices, and provider device elasticity metrics, the disclosed systems can assign a consolidated transportation value across provider devices. For instance, the disclosed systems can utilize optimization models to determine transportation value modifiers from the consolidated transportation value for provider devices for responding to a transportation requests from requestor devices during certain time periods. For example, the disclosed system can generate a forecasted transportation value schedule illustrating the plurality of transportation modifiers and the corresponding plurality of time periods and provide for display a graphical user interface of the forecasted transportation value schedule on the provider device. Upon detecting the provider device initiating a transportation service during one of the time periods, the transportation value modifier system can surface on the provider device a transportation value increase element based on the transportation value modifier that corresponds to the time period. In this manner, the disclosed systems can utilize forecasting and optimization models to pre-emptively provide user interfaces to provider devices that accurately account for and modulate provider-requestor device imbalances to improve predictability and efficiency across a transportation network.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a transportation value modifier system can operate in accordance with one or more embodiments.

FIG. 2 illustrates an overview of a transportation value modifier system generating transportation value modifiers and providing for display on a provider device a forecasted transportation value schedule in accordance with one or more embodiments.

FIGS. 3A-3B illustrate the transportation value modifier system utilizing an optimization model to determine a subset of transportation value modifiers and provider device elasticity metrics in accordance with one or more embodiments.

FIGS. 4A-4C illustrate exemplary graphical user interfaces of a provider device in accordance with one or more embodiments.

FIGS. 5A-5B illustrate improved network device balance utilizing the transportation value modifier system and assigning a consolidated transportation value for a plurality of provider devices in accordance with one or more embodiments.

FIG. 6 illustrates a flowchart of a series of acts for generating a forecasted transportation value schedule in accordance with one or more embodiments.

FIG. 7 illustrates a block diagram of an example computing device for implementing one or more embodiments of the present disclosure.

FIG. 8 illustrates a block diagram of an example transportation value modifier system in accordance with one or more embodiments.

### DETAILED DESCRIPTION

This disclosure describes one or more embodiments of a transportation value modifier system that utilizes forecasting and optimization models to generate dynamic provider device user interfaces with future transportation value modifiers to improve device network imbalances. In particular, the disclosed systems can utilize the optimization model to analyze predicted requestor devices, predicted provider devices, and a plurality of provider device elasticity metrics for the plurality of time periods to assign a consolidated transportation value and determine transportation value modifiers for the plurality of time periods that improves utilization and balances the number of provider devices and the number of requestor devices during the plurality of time periods. In one or more embodiments, the transportation value modifier system provides a graphical user interface with a forecasted transportation value schedule comprising the plurality of transportation value modifiers and the plurality of time periods. Upon detecting an initiation of a transportation service by the provider device during a time period from the plurality of time periods surfaced in the forecasted transportation value schedule, the transportation value modifier system can surface a transportation value increase element based on the transportation value modifier that corresponds to the time period on the provider device.

As indicated above, the transportation value modifier system can generate a plurality of transportation value modifiers for a plurality of time periods. In particular, the transportation value modifier system can utilize an optimization model to assign a consolidated transportation value for provider devices via the transportation modifiers based on predicted requestor devices, predicted provider devices, and a plurality of provider device elasticity metrics that correspond to the plurality of times. In some cases, the transportation value modifier system can determine the consolidated transportation value based on a difference between a legacy base transportation value and a modified base transportation value. For example, the transportation value modifier system can determine the modified base transportation value by modifying (e.g., decreasing) the legacy base transportation value across the plurality of time periods by a percentage, ratio, or flat amount. Indeed, by implementing the modified base transportation value and redistributing the consolidated transportation value, the transportation value modifier system can increase transportation matches without increasing the overall number of provider device driving hours over the plurality of time periods. For example, the modified base transportation value can shift provider devices or provider device driving hours away from high-provider-device imbalance time periods to high-requestor-device imbalance time periods resulting in more overall transportation matches across the plurality of time periods.

In some embodiments, the transportation value modifier system can utilize the optimization model to determine which time periods should correspond to transportation value modifiers and the size of the transportation value modifiers from the consolidated transportation value based on the predicted requestor devices, predicted provider devices, and the plurality of provider device elasticity metrics. Indeed, the optimization model can determine how to redistribute or assign the consolidated transportation value to the transportation value modifiers to generate more transportation matches between provider devices and requestor devices across the plurality of time periods.

Additionally, the transportation value modifier system can generate a forecasted transportation value schedule that includes the plurality of transportation value modifiers and the plurality of time periods. In particular, the transportation value modifier system can provide for display the forecasted transportation value schedule on a graphical user interface of the provider device where the transportation value modifier system can inform the provider device of all of the upcoming time periods that correspond to transportation value modifiers.

Furthermore, the transportation value modifier system can detect when the provider device initiates or provides a transportation service during a time period from the plurality of time periods, and in response, the transportation value modifier system can provide for display a transportation value increase element indicating or confirming the application of the transportation value modifier for the time period. For example, the transportation value increase element can be based on a transportation value modifier corresponding to the time period.

In one or more embodiments, the transportation value modifier system utilizes transportation value modifiers to efficiently manage provider devices to improve the balance of provider devices and requestor devices. For example, the transportation value modifier system can utilize an optimization model to determine transportation value modifiers that increase the number of available provider devices to more closely match the number of requestor devices and improve the overall utilization of provider devices across time and/or location (e.g., space).

As just suggested, the transportation value modifier system provides several technical improvements or advantages over conventional systems. For instance, the transportation value modifier system can improve the computational efficiencies of existing systems. More specifically, by improving the balance between provider devices and requestor devices across the network, the transportation value modifier system can significantly improve the efficiency of implementing devices/servers. For instance, the transportation value modifier system can utilize a transportation value schedule with transportation value modifiers to look ahead and proactively modulate high requestor demand time periods by applying transportation value modifiers to upcoming or predicted unbalanced time periods. For example, the transportation value modifier system can determine for an upcoming week when the number of online/active requestor devices will exceed the number of online/active provider devices for an application. In such instances, the transportation value modifier system can increase the number of provider devices by pre-emptively forecasting, optimizing, and generating transportation value modifiers for those upcoming time periods. Indeed, by increasing the number of provider devices, the transportation value modifier system decreases duplicative requests, decreases time, decreases bandwidth, and decreases needed computational resources per transportation match.

Notably, the transportation value modifier system can also improve device imbalances and efficiency by determining a consolidated transportation value to assign across time periods (e.g., from a legacy transportation value and modified base transportation value for other time periods). Indeed, the foregoing example discusses improving provider device and requestor device imbalances during a high-requestor device imbalance period; however, in one more embodiments, the transportation value modifier system determines a consolidated transportation value from the difference between a legacy base transportation value and a modified base transportation value and assigns the consolidated transportation value to different time periods to increase the transportation value for some time periods and decrease the transportation value for other time periods. This not only increases the number of provider devices for high-requestor-device imbalance time periods but also reduces the number of provider devices for high-provider-device imbalance time periods. Indeed, paradoxically, although the transportation value modifier system can reduce transportation values for high-provider-device imbalance time periods it can improve efficiency for provider devices during such time periods. For instance, by reducing the number of provider devices during high-provider-device imbalance time periods, the transportation value modifier system can improve network balances, increase utilization, and increase overall transportation value received from participating provider devices. Thus, by deriving a consolidated transportation value from a legacy base transportation value across time periods and then assigning the consolidated transportation to different time periods, the transportation value modifier system improves efficiency for both high-requestor device and high-provider device imbalances across time periods.

Moreover, the transportation value modifier system improve efficiency by reducing the number of user interactions and cross-utilization between different computing applications. For example, by balancing the number of requestor devices and provider devices across time periods, the transportation value modifier system transportation value modifier system reduces time, duplicative requests, unnecessary user interface interactions, restarting requestor applications, and/or navigation to different mobile applications. The transportation value modifier system improves efficiency by avoiding the iterative cycle of switching between applications during periods of device network imbalances to find compatible transportation matches.

As indicated by the foregoing discussion, the present disclosure utilizes a variety of terms to describe the features and advantages of the transportation value modifier system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider-or a device associated with an autonomous vehicle that drives along transportation routes.

Relatedly, as used herein, the term “predicted provider device” refers to a forecasted, estimated, or predicted number or amount of provider devices that are available or online to accept a transportation request from a requestor device or provide a transportation service. In one or more embodiments a predicted provider device can correspond to predicted provider device hours indicating an estimate of how many hours a predicted provider device provides transportation services for a given time period. In some implementations, the transportation value modifier system can utilize one or more forecasting models, machine-learning models, or forecasting sets to determine a number of predicted provider devices and/or predicted provider device hours for a plurality of time periods.

As suggested above, the term “requestor device” refers to a computing device associated with a requestor that submits a transportation request to a transportation matching system. For instance, a requestor device receives interaction from a requestor in the form of user interaction to submit a transportation request. After the transportation matching system matches a requestor (or a requestor device) with a provider (or a provider device), the requestor can await pickup by the provider at a predetermined pick-up location. Upon pick-up, the provider transports the requestor to a drop-off location specified in the requestor's transportation request. Accordingly, a requestor may refer to (i) a person who requests a request or other form of transportation but who is still waiting for pickup, (ii) a person who requests a request or other form of transportation for another person, or (iii) a person whom a transportation vehicle has picked up and who is currently riding within the transportation vehicle to a drop-off location.

Relatedly, as used herein, the term “predicted requestor device” refers to a forecasted, estimated, or predicted number or amount of requestor devices submitting a transportation request during a time period. For example, the transportation value modifier system can determine the number of predicted requestor devices for any given hour for each day of the week. In some implementations, a predicted requestor device can correspond to a requestor device intent reflecting an estimated number of transportation requests made by one or more requestor devices. In one or more embodiments, the transportation value modifier system can utilize one or more forecasting models, machine-learning models, and/or forecasting sets to determine a number of predicted requestor devices making transportation requests for a plurality of time periods within a region.

As used herein, the term “transportation request” refers to a request from a requesting device (i.e., a requestor device) for transport by a transportation vehicle. In particular, a transportation request includes a request for a transportation vehicle to transport a requestor or a group of individuals from one geographic area to another geographic area. A transportation request can include information such as a pick-up location, a destination location (e.g., a location to which the requestor wishes to travel), a request location (e.g., a location from which the transportation request is initiated), location profile information, a requestor rating, or a travel history. As an example of such information, a transportation request may include an address as a destination location and the requestor's current location as the pick-up location. A transportation request can also include a requestor device initiating a session via a transportation matching application and transmitting a current location (thus, indicating a desire to receive transportation services from the current location).

As used herein, the term “transportation value modifier” refers to an adjustment applied to a transportation value for completing a transportation service. In some embodiments, a transportation value modifier can be a ratio, percentage, or multiplier increasing the transportation value for completing the transportation service. For example, the transportation value modifier can be a multiplier applied to the transportation service amount of the transportation service. In one or more implementations, a transportation value modifier corresponds to a time period. For example, a transportation value modifier can be X1.5 for a time period from 1:00-2:00. Further, as used herein, the term “time period” refers to an amount of time. For example, a time period can be an hour. In some cases, the time period can range from five minutes to a couple of hours.

Additionally, as used herein, the term “forecasted transportation value schedule” refers to a schedule reflecting one or more transportation value modifiers and corresponding future time periods. For example, a forecasted transportation value schedule can include a list of transportation value modifiers and corresponding time periods for the upcoming length of time. For example, the forecasted transportation value schedule can show the transportation value modifiers for a given hour in an upcoming week. In some cases, the forecasted transportation value schedule is fixed for the upcoming length of time (e.g., week). For example, the transportation value modifier system can generate a forecasted transportation value schedule comprising a transportation value modifier for every hour from a Sunday to the following Saturday.

As used herein, the term “transportation value increase element” refers to an indicator or symbol reflecting a change in a transportation value (e.g., transportation service amount) for completing a transportation service during a time period. In one or more embodiments, the transportation value increase element shows the change in the transportation value based on the transportation value modifier corresponding to the time period of providing or completing the transportation service.

As used herein, the term “provider device elasticity metric” refers to a measure, metric, or value reflecting a change in the number of provider devices and/or provider device hours for a given time period in response to a particular stimulus or variable. In one or more embodiments, the provider device elasticity metric can reflect an increase and/or decrease of the provider devices and/or provider device hours in response to a transportation value modifier.

As used herein, the term “optimization model” refers to an algorithm, set of operations, set of functions, or processes that modifies a variable to improve or optimize another variable. For instance, an optimization model can change transportation value modifiers to improve or optimize an efficiency metric, such as the number of transportation matches between provider devices and requestor devices (or provider device utilization). In one or more embodiments, an optimization model can process the number of predicted provider devices, predicted requestor devices, and provider elasticities to generate a plurality of transportation value modifiers for a plurality of time periods to improve the number of transportation matches between provider devices and requestor devices. In some cases, the optimization model can be a machine-learning model.

Moreover, as used herein, the term “consolidated transportation value” refers to a measure, value, amount, and/or budget for distribution during one or more time periods. In some cases, the consolidated transportation value is based on modifying a legacy base transportation value or earnings levels of provider devices across all time periods. For example, the consolidated transportation value can correspond to the change in the legacy base transportation value or earnings level. For instance, the consolidated transportation value can be 5% based on the transportation value modifier system decreasing the legacy base transportation value or overall earnings levels by 5% across all time periods to a modified base transportation value. In one or more embodiments, the transportation value modifier system can redistribute the consolidated transportation value via the plurality of transportation value modifiers for the plurality of time periods.

As used herein, the term “machine-learning,” refers to the process of constructing and implementing algorithms that can learn from and make predictions on data. For example, a machine-learning model can utilize algorithms to learn from, and make predictions on, known data by analyzing the known data to learn to generate outputs that reflect patterns and attributes of the known data. Thus, a machine-learning model makes high-level abstractions in data by generating data-driven predictions or decisions from the known input data. In various embodiments, a machine-learning model can include but is not limited to, support vector machines, linear regression, logistic regression, Bayesian networks, clustering K-nearest neighbors (KNN), K-means, random forest learning, dimensionality reduction algorithms, boosting algorithms, artificial neural networks, deep learning, etc.

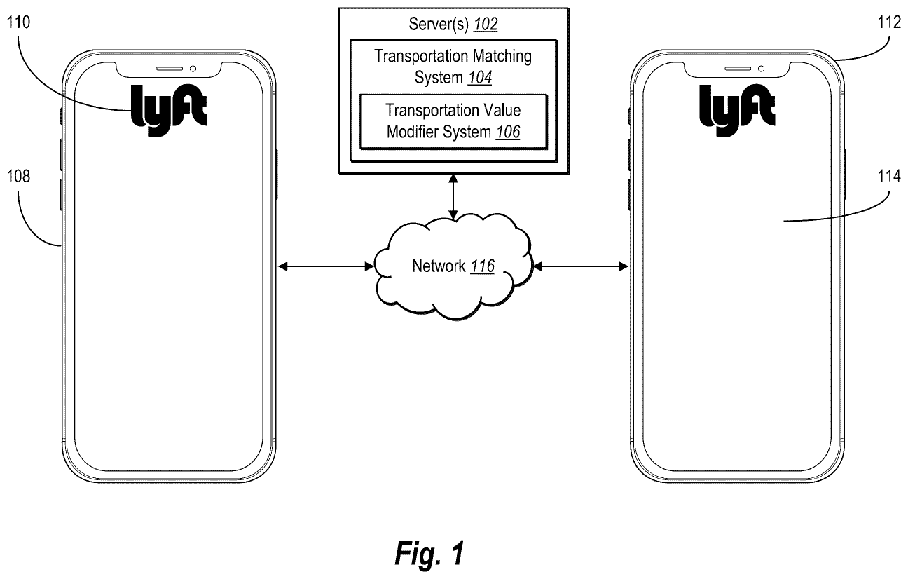

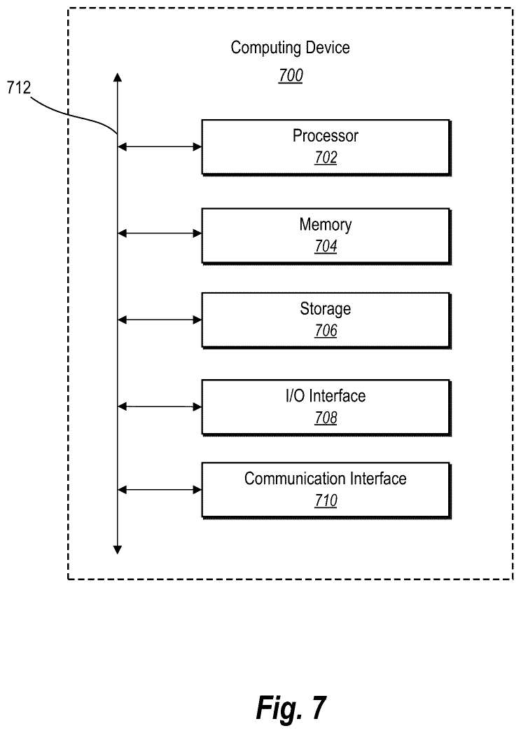

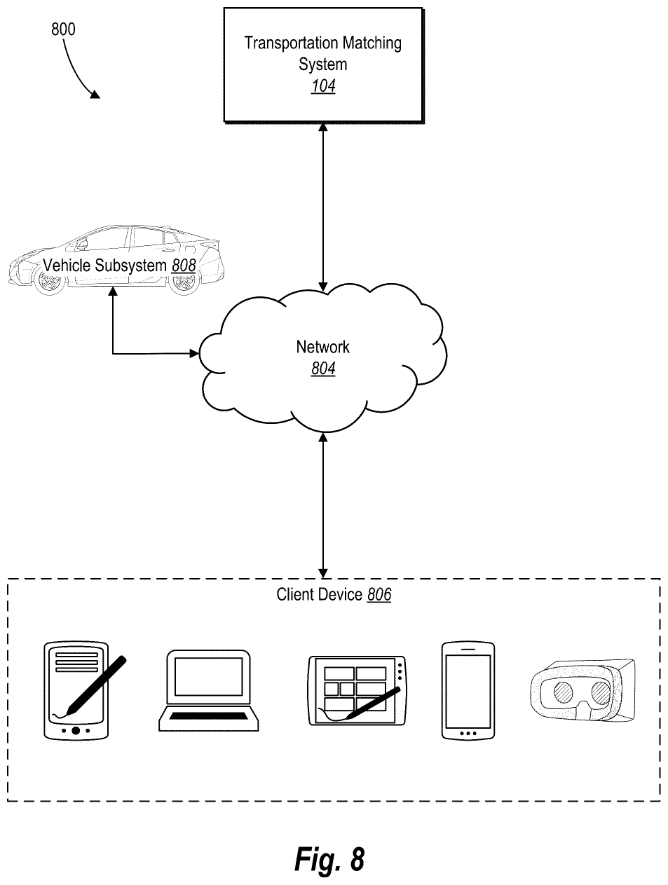

Additional detail regarding the transportation value modifier system will now be provided with reference to the figures. In particular, FIG. 1 illustrates a block diagram of a system environment for implementing a transportation value modifier system in accordance with one or more embodiments. As shown in FIG. 1, the environment includes server(s) 102 housing the transportation value modifier system 106 as part of a transportation matching system 104. The environment of FIG. 1 further includes a provider device(s) 108 (including a provider application 110) and a requestor device(s) 112 (including a requestor application 114), as well as a network 116. The server(s) 102 can include one or more computing devices to implement the transportation value modifier system 106. Additional detail regarding the illustrated computing devices (e.g., the server(s) 102, the provider device(s) 108, the requestor device(s) 112, and/or the third-party system(s)) is provided with respect to FIGS. 7-8 below.

As shown, the transportation value modifier system 106 utilizes the network 116 to communicate with the provider device(s) 108 and the requestor device(s) 112. The network 116 may comprise any network described in relation to FIGS. 7-8. For example, the transportation value modifier system 106 communicates with the provider device(s) 108 and the requestor device(s) 112 to match transportation requests received from the requestor device(s) 112 with the provider device(s) 108. Indeed, the transportation matching system 104 or the transportation value modifier system 106 can receive a transportation request from the requestor device(s) 112 and can provide request information to various provider devices, such as a requested location (e.g., a requested pickup location and/or a requested drop-off location), a requestor identification (e.g., for a requestor corresponding to the requestor device(s) 112), and an indication of whether a transportation service corresponding to the transportation request occurs during a time period associated with a transportation value modifier. In some embodiments, per device settings, the transportation matching system 104 or the transportation value modifier system 106 receives device information from various provider devices and the requestor device(s) 112, such as location coordinates (e.g., latitude, longitude, and/or elevation), orientations or directions, motion information, and indications of user interactions with various interface elements.

To facilitate connecting transportation requests with transportation vehicles, in some embodiments, the transportation matching system 104 or the transportation value modifier system 106 communicates with the provider device(s) 108 and other provider devices (e.g., through a provider application 110). As indicated by FIG. 1, the provider device(s) 108 includes the provider application 110. In many embodiments, the transportation matching system 104 or the transportation value modifier system 106 communicates with the provider device(s) 108 through the provider application 110 to, for example, receive and provide information including location data, motion data, transportation request information (e.g., pickup locations and/or drop-off locations), transportation route information for navigating to one or more designated locations, and a plurality of transportation value modifiers for a plurality of time periods. Further, in some embodiments, the transportation value modifier system 106 communicates with the provider device(s) 108 through the provider application 110 to provide a forecasted transportation value schedule to the provider device(s) 108 and, in response to detecting an initiation of a transportation service by the provider device(2) 108, provide a transportation value increase element based on a transportation value modifier corresponding to the time period.

Similarly, the transportation matching system 104 or the transportation value modifier system 106 communicates with the requestor device(s) 112 (e.g., through the requestor application 114) to facilitate connecting requests with transportation vehicles. In many embodiments, the transportation value modifier system 106 communicates with the requestor device(s) 112 through the requestor application 114 to, for example, receive and provide information including location data, motion data, transportation request information (e.g., requested locations), and navigation information to guide a requestor to a designated location.

As indicated above, the transportation matching system 104 or the transportation value modifier system 106 can provide (and/or cause the provider device(s) 108 to display or render) visual elements within a graphical user interface associated with the provider application 110 and the requestor application 114. For example, the transportation matching system 104 or the transportation value modifier system 106 can provide a digital map for display on the provider device(s) 108 that illustrates a transportation route to navigate to a designated location. The transportation value modifier system 106 can also provide a transportation request notification for display on the provider device(s) 108 indicating a transportation request. Further, the transportation value modifier system 106 can provide a transportation value modifier notification for a plurality of time periods.

Moreover, as indicated, the transportation value modifier system 106 provides a user interface via the requestor device(s) 112 that includes selectable options for various types of transportation requests (e.g., a standard transportation request).

Although FIG. 1 illustrates the environment having a particular number and arrangement of components associated with the transportation value modifier system 106, in some embodiments, the environment may include more or fewer components with varying configurations. For example, in some embodiments, the transportation matching system 104 or the transportation value modifier system 106 can communicate directly with the provider device(s) 108 and/or the requestor device(s) 112, bypassing the network 116. In these or other embodiments, the transportation matching system 104 or the transportation value modifier system 106 can be housed (entirely on in part) on the provider device(s) 108 and/or the requestor device(s) 112. Additionally, the transportation matching system 104 or the transportation value modifier system 106 can include or communicate with a database for storing information, such as various machine learning models, historical data (e.g., historical provider device and/or requestor device patterns), predicted data (e.g., predicted requestor devices and/or predicted provider devices), transportation requests, and/or other information described herein.

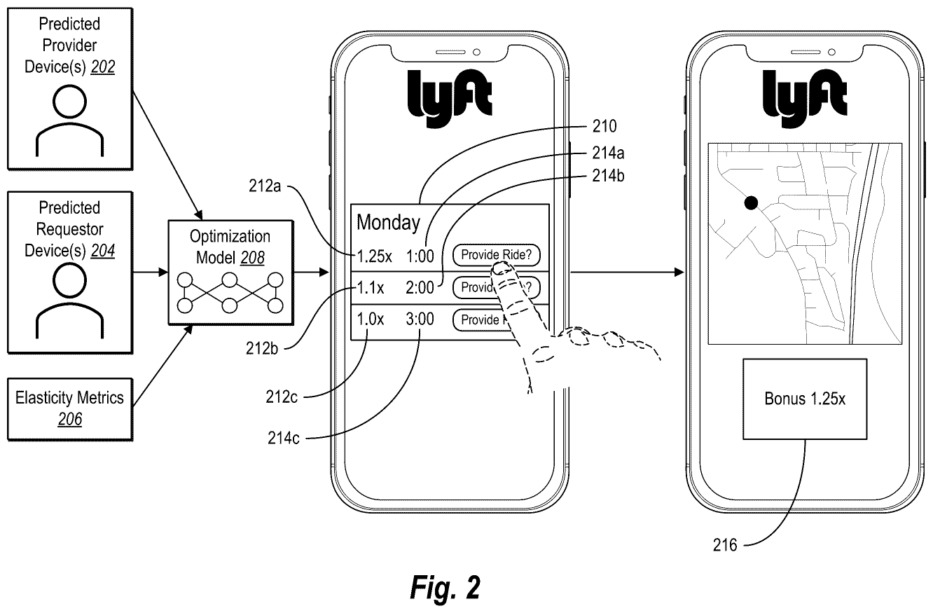

As mentioned previously, in one or more embodiments, the transportation value modifier system 106 generates a forecasted transportation value schedule with a plurality of transportation value modifiers and a plurality of time periods that improve the network imbalances between provider devices and requestor devices across time. FIG. 2 illustrates an overview of a transportation value modifier system generating a plurality of transportation value modifiers for a plurality of time periods and providing for display on a provider device a forecasted transportation value schedule in accordance with one or more embodiments.

As shown in FIG. 2, the transportation value modifier system 106 can determine predicted provider device(s) 202, predicted requestor device(s) 204, and a plurality of provider device elasticity metrics 206 for a plurality of time periods. For example, in one or more embodiments, the transportation value modifier system 106 can utilize one or more sets of forecasts and/or forecasting models to determine the demand and/or number of predicted provider device(s) 202 and/or predicted requestor device(s) 204 for any given time period throughout a week (e.g., length of time). In some cases, the transportation value modifier system 106 can further determine the plurality of provider device elasticity metrics 206 by layering a model, adjusting provider device features, and/or applying functions to the sets of forecasts (e.g., baseline forecast).

As further shown in FIG. 2, the transportation value modifier system 106 can determine a plurality of transportation value modifiers 212a-c by utilizing an optimization model 208 to process and/or analyze the predicted provider device(s) 202, the predicted requestor device(s) 204, and the plurality of provider device elasticity metrics 206. For example, the optimization model 208 can determine a transportation value modifier for a given time period that can improve or increase the number of transportation matches between the provider device(s) 202 and the requestor device(s) 204 during that time period.

As further shown in FIG. 2, the transportation value modifier system 106 can provide for display a forecasted transportation value schedule 210 on a graphical user interface of a provider device(s) 202. As FIG. 2 illustrates, the forecasted transportation value schedule 210 includes a plurality of transportation value modifiers 212a-c for a plurality of time periods 214a-c. As indicated in FIG. 2, the plurality of transportation value modifiers 212a-c can correspond to the plurality of time periods 214a-c. As indicated above, the plurality of transportation value modifiers 212a-c does not change once generated and provided for display within the forecasted transportation value schedule 210 on the provider device. For example, the transportation value modifier system 106 can generate the forecasted transportation value schedule 210 for an upcoming week and the provider device can depend on the forecasted transportation value schedule 210 to plan ahead and select time periods for providing transportation services.

In one or more embodiments, the transportation value modifier system 106 can detect an initiation of a transportation service by the provider device(s) 202 during a time period in the forecasted transportation value schedule 210. In such cases, the transportation value modifier system 106 can provide for display a transportation value increase element 216 based on the transportation value modifier 212a corresponding to the time period 214a. Indeed, the transportation value increase element 216 can reflect the effect of applying the transportation value modifier 212a to a transportation service amount for completing the transportation service.

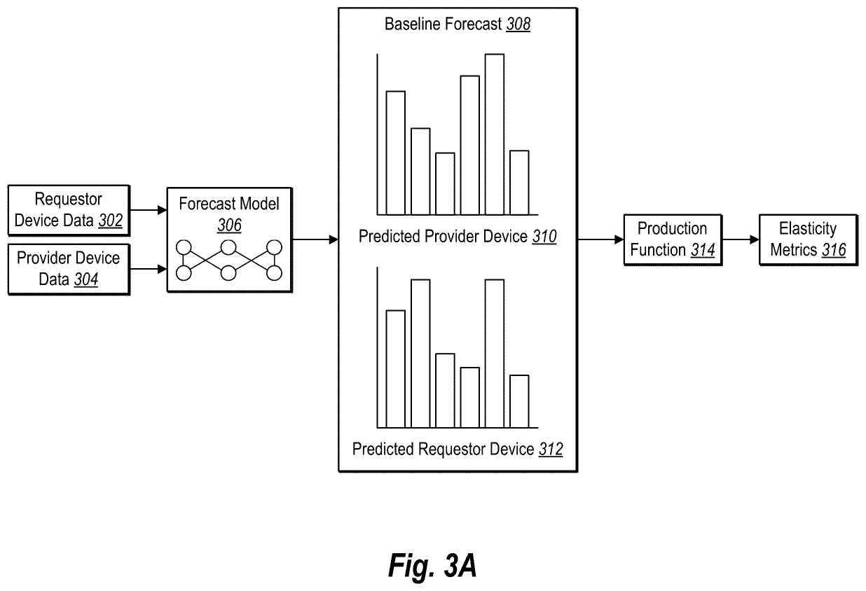

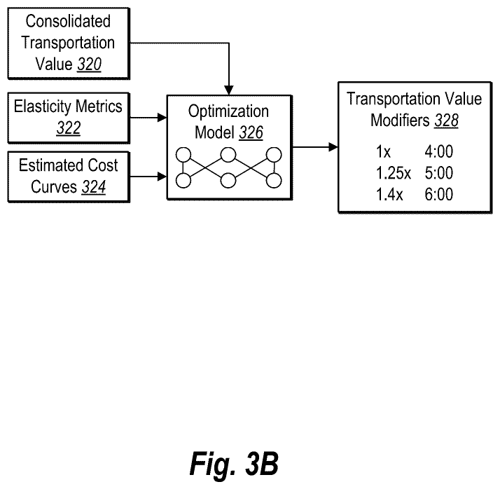

As just discussed, the transportation value modifier system 106 can utilize an optimization model to improve and/or increase the number of transportation matches between provider devices and requestor devices for a number of time periods. More specifically, the transportation value modifier system 106 can determine a subset of transportation value modifiers for a subset of time periods that improves an objective number of transportation matches between provider devices and requestor devices. FIGS. 3A-3B illustrate the transportation value modifier system utilizing an optimization model to determine a subset of transportation value modifiers and provider device elasticity metrics in accordance with one or more embodiments. In particular, FIG. 3A shows the transportation value modifier system 106 determining provider device elasticity metrics in accordance with one or more embodiments.

As shown in FIG. 3A, the transportation value modifier system 106 can forecast a number of predicted provider devices 310 and/or a number of predicted requestor devices 312 for a time period within given region. Indeed, in one or more embodiments, the transportation value modifier system 106 can utilize requestor device data 302, provider device data 304, and a forecast model 306 to generate a baseline forecast 308 indicating the number of predicted provider devices 310 and number of predicted requestor devices 312 for a time period within the region.

In some embodiments, the requestor device data 302 can be and/or include historic requestor device data. In one or more cases, the historic requestor device data can include the number of historic requestor device intents corresponding to the historic requestor device data. In some cases, the number of historic requestor device intents can reflect a number or amount of transportation requests made from one or more requestor devices during one or more prior time periods. For example, the historic requestor device data can report that the transportation matching system 104 received 1,000 transportation requests from a plurality of requestor devices from 4:00 PM to 5:00 PM on the previous Thursday within a region of a city.

As mentioned above and further shown in FIG. 3A, the transportation value modifier system 106 can utilize provider device data 304. In some cases, the provider device data 304 can include historic provider device data indicating the number of historic provider device hours corresponding to the number of provider devices for a time period within the region. For example, the transportation value modifier system 106 can determine the number of historic provider device hours performed for a single provider device along with the number of historic provider device hours for a collection of provider devices providing transportation services within a region. For example, the transportation value modifier system 106 can determine that provider devices generated 300 historic provider device hours from 4:00 PM to 5:00 PM on the previous Thursday within the region of the city.

As further shown in FIG. 3A, the transportation value modifier system 106 can input the requestor device data 302 and the provider device data 304 into a forecast model 306 to generate the baseline forecast 308 for a plurality of upcoming time periods within the region. Indeed, the transportation value modifier system 106 can utilize the forecast model 306 to predict, estimate, and/or forecast a number of predicted provider devices and a number of predicted requestor devices for a plurality of upcoming time periods for the region. In some embodiments, the forecast model 306 can be a machine-learning model, algorithm, and/or forecasting set. For example, in one or more implementations, the forecast model 306 can utilize a linear quadratic estimation (e.g., Kalman filter) or a Gaussian model on historic provider device data (e.g., historic provider device hours) to determine the number of predicted provider devices corresponding to predicted provider device hours on the transportation matching system 104 for one or more upcoming time periods within the region. To further illustrate, in one or more embodiments, the transportation value modifier system 106 can input the historic requestor device data (e.g., historic requestor device intents) into the forecast model 306 to determine the number of predicted requestor devices corresponding to predicted requestor device intents for one or more upcoming time periods within the region. Thus, the transportation value modifier system 106 can determine or predict the number of provider devices available for transportation services for any given hour in any given day of the week and utilize the prediction to determine provider device elasticity metrics.

As just discussed, the transportation value modifier system 106 can generate a baseline forecast 308 by inputting the requestor device data 302 and the provider device data 304 into the forecast model 306. Indeed, the baseline forecast 308 can reflect the number of predicted provider devices 310 and the number of predicted requestor devices 312 for a plurality of time periods within the region. For example, the baseline forecast 308 can indicate the number of predicted requestor devices (e.g., predicted requestor device intents) and the number of predicted provider devices (e.g., predicted provider device hours) from the 5:00-6:00 PM time period for the upcoming Thursday. Indeed, the transportation value modifier system 106 can generate the baseline forecast 308 providing a region-hour forecast for multiple days or weeks of the number of provider devices and the number of requestor devices within a region.

Moreover, in one or more embodiments, the transportation value modifier system 106 can modify the baseline forecast 308 by considering the effects of events (e.g., concerts, sporting events, conventions, etc.) and/or experimental data reflecting the effects of prior transportation value modifiers on the number of predicted requestor devices 312 and the number of predicted provider devices 310. For example, the transportation value modifier system 106 can generate one or more multipliers corresponding to the effects of the event and apply the multipliers to the baseline forecast 308.

Moreover, the transportation value modifier system 106 can identify experimental data showing how one or more transportation value modifiers affected the number of predicted requestor devices 312 and the number of predicted provider devices 310 and a consolidated transportation value (e.g., monetary value) associated with balancing the number of predicted requestor devices 312 and the number of predicted provider devices 310. In some embodiments, the transportation value modifier system 106 can generate one or more cost curves from the experimental data and analyze the cost curves to determine how to assign the consolidated transportation value to the transportation value modifiers.

As further shown in FIG. 3A, the transportation value modifier system 106 can apply a production function 314 to the baseline forecast 308 to determine a plurality of provider device elasticity metrics 316. In particular, the transportation value modifier system 106 can utilize the production function 314 to determine and/or predict the number of transportation matches generated by the transportation value modifiers. In one or more embodiments, the transportation value modifier system 106 can utilize a customized cobb-douglas production function with adjusted density metrics and/or attributes. In one or more cases, the transportation value modifier system 106 can take the derivative of the customized cobb-douglas function to determine the plurality of provider device elasticity metrics 316 for the plurality of time periods. In some cases, the transportation value modifier system 106 can utilize the plurality of provider device elasticity metrics 316 to further estimate the number of generated transportation matches given the increase in the number of provider devices (e.g., provider device hours) during the plurality of time periods.

As just discussed, the transportation value modifier system 106 can determine a plurality of provider device elasticity metrics for a plurality of time periods based on at least a baseline forecast and a production function. FIG. 3B illustrates the transportation value modifier system 106 utilizing the plurality of provider device elasticity metrics and an optimization model to determine a plurality of transportation value modifiers for a plurality of time periods according to one or more embodiments.

As discussed above, the transportation value modifier system 106 can determine a plurality of provider device elasticity metrics for a plurality of time periods. As mentioned above and further shown in FIG. 3B, the transportation value modifier system 106 can generate one or more estimated cost curves reflecting the increase of the number of predicted provider devices and/or predicted provider device hours for a time period and the amount of additional monies spent during the time period. For example, the transportation value modifier system 106 can collect data regarding the monetary value associated with funding historic and/or experimental transportation value modifiers and how the historic and/or experimental transportation value modifiers increased the number of provider device hours for the time period.

As shown in FIG. 3B, the transportation value modifier system 106 can utilize a consolidated transportation value 320, the one or more estimated cost curves 324, and a plurality of provider device elasticity metrics 322 in conjunction with an optimization model 326 to determine a plurality of transportation value modifiers 328. In particular, the optimization model 326 can determine how to distribute the consolidated transportation value 320 across a plurality of time periods via the plurality of transportation value modifiers 328 to improve an objective of a number of transportation matches between provider devices and requestor devices across time.

In one or more embodiments, the transportation value modifier system 106 can determine the consolidated transportation value 320 based on a difference between a legacy base transportation value and a modified base transportation value. For example, the transportation value modifier system 106 can lower the legacy base transportation value to the modified base transportation value. In some embodiments, the transportation value modifier system 106 lowers the legacy base transportation value by a percentage, ratio, or flat amount and determines the consolidated transportation value 320 based on the modifying percentage, ratio, or flat amount.

Moreover, in one or more embodiments, the transportation value modifier system 106 can identify the modified base transportation value and consolidated transportation value 320 that are predicted to generate the most transportation matches for an upcoming length of time. For example, based on the effect of one or more previous modified base transportation values and/or consolidated transportation value 320, the transportation value modifier system 106 can modify or decrease the legacy base transportation value in a manner that will generate a consolidated transportation value 320 that increases the number of provider devices or provider device driving hours at high-requestor-device imbalance time periods.

Additionally, in some cases, the transportation value modifier system 106 can determine the consolidated transportation value 320 based on the modified base transportation value and one or more incentivizing budgets. For example, the transportation value modifier system 106 can reduce the legacy base transportation value and the one or more incentivizing budgets to generate the consolidated transportation value 320. In some cases, the transportation value modifier system 106 can generate the consolidated transportation value 320 specific to one or more regions or sub-regions. For example, the transportation value modifier system 106 can generate a first consolidated transportation value for a first region and a second consolidated transportation value for a second region. In some cases, the transportation value modifier system 106 can utilize one or more incentivizing budgets to feed into the consolidated transportation value. For example, in one or more implementations, the transportation value modifier system 106 can maintain the legacy base transportation value and generate the consolidated transportation value from the one or more incentivizing budgets

As FIG. 3B illustrates, the transportation value modifier system 106 can utilize the consolidated transportation value 320, the plurality of provider device elasticity metrics 322, and the one or more estimated cost curves 324 in conjunction with the optimization model 326. In particular, the optimization model 326 can determine, based on the consolidated transportation value 320, the plurality of provider device elasticity metrics 322, and the one or more estimated cost curves 324, how to distribute the consolidated transportation value 320 to generate the plurality of transportation value modifiers 328 for the plurality of time periods. In particular, the transportation value modifier system 106 can utilize the optimization model 326 to determine a subset of transportation value modifiers, generated from the consolidated transportation value 320, for a subset time periods that improves an objective of the number of transportation matches between the provider devices and the requestor devices for the plurality of time periods. For instance, the transportation value modifier system 106 can utilize the consolidated transportation value 320 and the optimization model 326 to increase the number of transportation matches during a high provider device imbalance time period. For example, the transportation value modifier system 106 can determine which time periods from the plurality of time periods should correspond to the plurality of transportation value modifiers 328 and the size and/or effect of the plurality of transportation value modifiers 328 based on redistributing the consolidated transportation value 320 to the plurality of transportation value modifiers 328. Indeed, the transportation value modifier system 106 can utilize the optimization model 326 to determine the most effective re-distribution or assignment of the consolidated transportation value 320 to generate more transportation matches. For example, as shown in FIG. 3B, the transportation value modifier system 106 can utilize the optimization model 326 to determine that the time period of 5:00-6:00 PM on an upcoming Thursday should have a transportation value modifier of X1.4 funded by the consolidated transportation value 320 because the X1.4 transportation value modifier will increase or improve the number of transportation matches between the provider devices and the requestor devices during the 5:00-6:00 PM time period.

As further shown in FIG. 3B, the transportation value modifier system 106 can generate the plurality of transportation value modifiers 328 that correspond to the plurality of time periods. Indeed, once the transportation value modifier system 106 determines the plurality of transportation value modifiers 328 from the consolidated transportation value 320 for the plurality of time periods, the transportation value modifier system 106 can generate a forecasted transportation value schedule where the plurality of transportation value modifiers 328 do not change until the transportation value modifier system 106 updates the plurality of transportation value modifiers for the plurality of time periods. For example, as described above in reference to FIG. 3A, the transportation value modifier system 106 can update the plurality of transportation value modifiers for the plurality of time periods based on a plurality of predicted requestor devices, a plurality of predicted provider devices, a plurality of provider device elasticities, the one or more estimated cost curves 324, and/or the consolidated transportation value 320 for the upcoming length of time. For example, the transportation value modifier system 106 can update from the existing week the plurality of transportation value modifiers for the plurality of time periods for the following or upcoming week (e.g., Sunday-Saturday) if the consolidated transportation value 320 for the upcoming week differs from the consolidated transportation value 320 for the existing week. Indeed, the transportation value modifier system 106 can detect one or more changes or differences amongst the plurality of predicted requestor devices, a plurality of predicted provider devices, a plurality of provider device elasticities, the one or more estimated cost curves 324, and/or the consolidated transportation value 320 for upcoming length(s) of time and accordingly adjust and/or update the plurality of transportation value modifiers for the plurality of time periods for the upcoming length(s) of time. Moreover, the transportation value modifier system 106 can provide for display, an updated forecasted transportation value schedule comprising the updated plurality of transportation value modifiers for the plurality of time periods for the upcoming length of time.

As discussed above, once the transportation value modifier system 106 detects an initiation of a transportation service by a provider device during a time period that corresponds to a transportation value modifier, the transportation value modifier system 106 can lock in the transportation value modifier corresponding to the time period and apply the transportation value modifier to the transportation service amount upon completing the transportation service. In one or more cases, the transportation value modifier system 106 can layer or utilize the plurality of transportation value modifiers 328 with other pricing and/or bonus models (e.g., Prime Time).

Furthermore, in some cases, the transportation value modifier system 106 can generate one or more transportation value modifiers specific to a provider device or group of provider devices. For instance, in some cases, the transportation value modifier system 106 can identify provider device features, such as, but not limited to, incentive responsiveness, common driving times, driving volume, and/or membership with other transportation applications. In one or more embodiments, the transportation value modifier system 106 can utilize the provider device features, the plurality of predicted provider devices, the plurality of predicted requestor devices, and the plurality of provider device elasticities to determine the increase in provider device hours for the provider device (or group of provider devices) based on the transportation value modifier (or increase to the transportation value service) and the consolidated transportation value 320.

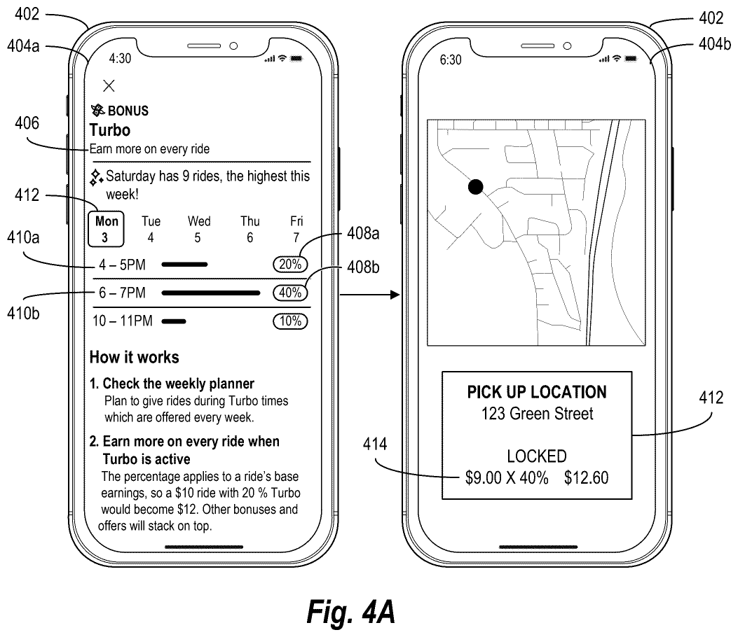

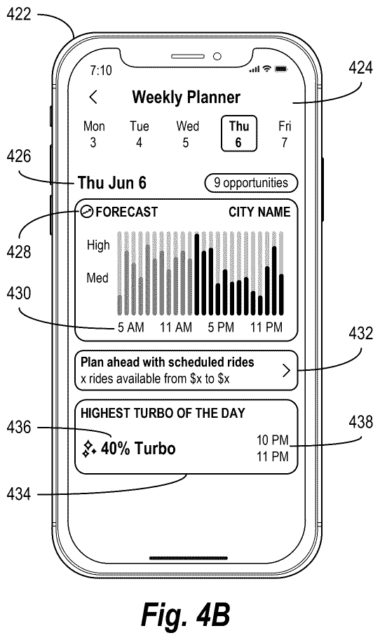

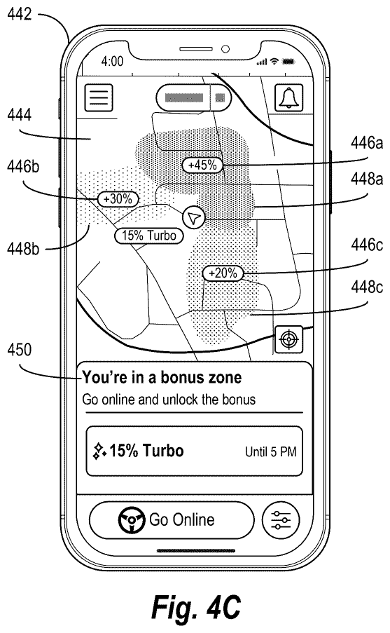

In one or more embodiments, once the transportation value modifier system 106 generates the plurality of transportation value modifiers for the plurality of time periods, the transportation value modifier system 106 can generate a forecasted transportation value schedule comprising the plurality of transportation value modifiers and the plurality of time periods. FIGS. 4A-4C illustrate exemplary graphical user interfaces of the forecasted transportation value schedule on the provider device in accordance with one or more embodiments. In particular, FIG. 4A illustrates an embodiment of the forecasted transportation value schedule.

As shown in FIG. 4A, the transportation value modifier system 106 can provide for display a forecasted transportation value schedule 406 on a first graphical user interface 404a of a provider device 402. As discussed above, the transportation value modifier system 106 can generate a forecasted transportation value schedule 406 for a given week by displaying the plurality of transportation value modifiers and the corresponding plurality of time periods. For example, as illustrated in FIG. 4A, the transportation value modifier system 106 can provide for display a first time period 410a corresponding to a first transportation value modifier 408a and a second time period 410b corresponding to a second transportation value modifier 408b. In particular, FIG. 4A shows for a day (e.g., Monday) within a given length of time (e.g., week), the first time period 410a of 4:00-5:00 PM corresponds with the first transportation value modifier 408a of 20%. Moreover, the second time period 410b of 6:00-7:00 PM corresponds with the second transportation value modifier 408b of 40%.

As indicated in FIG. 4A, in some cases, the transportation value modifier system 106 can receive a selection of a given day and provide for display one or more subsets of transportation value modifiers of the plurality of transportation value modifiers and one or more corresponding subsets of time periods of the plurality of time periods for that day. Indeed, the transportation value modifier system 106 can inform a provider device of transportation value modifiers and corresponding time periods for each day for the upcoming week allowing the provider device to track and determine when would be best to initiate and/or provide a transportation service for a requestor device. In some cases, the transportation value modifier system 106 can filter the plurality of time periods and/or the plurality of transportation value modifiers. For example, the transportation value modifier system 106 can only show a subset of time periods that correspond to specific transportation value modifier.

As further shown in FIG. 4A, in response to detecting initiation of a transportation service by the provider device 402, the transportation value modifier system 106 can provide a transportation value increase element 412 for display on a second graphical user interface 404b of the provider device 402 based on the transportation value modifier corresponding to the time period. For example, as shown in FIG. 4A, based on the transportation value modifier system 106 detecting the provider device 402 initiating a transportation service at 6:30 PM, the transportation value modifier system 106 can provide for display the transportation value increase element 412 indicating that the transportation service amount will increase by 40% because the transportation service initiated during the second time period 410b 6:00-7:00 PM and the second time period 410b corresponds to the second transportation value modifier 408b.

Relatedly, as indicated by FIG. 4A, the transportation value modifier system 106 can lock in the transportation value modifier corresponding to the time period and apply the transportation value modifier to a transportation service amount 414 upon completion of the transportation service by the provider device 402. For example, as FIG. 4A shows, the transportation value modifier system 106 will fund the account of the provider device 402 $12.60 upon completion of the transportation service. In one or more implementations, the transportation value modifier system 106 automatically locks in the transportation value modifier (e.g., upon detecting a transportation service during a time corresponding to the transportation value modifier and without requiring user selection of an element or indicator corresponding to the transportation value modifier).

As discussed above and shown in FIG. 4B, in one or more embodiments, the transportation value modifier system 106 can display on a graphical user interface 424 of a provider device 422 the forecasted transportation value schedule 426 with a plurality of transportation value modifiers for a plurality of transportation time periods. In one or more embodiments, forecasted transportation value schedule 426 can show a number of provider devices forecast 428 for one or more provider devices for the plurality of time periods 430, indicating which of the time periods from the plurality of time periods 430 has a high imbalance (e.g., predicted high imbalance) of provider devices (or provider device hours). As indicated by the number of provider devices forecast 428 in FIG. 4B, a higher imbalance of provider devices (or provider device hours) for a specific time period can correspond to a higher transportation value modifier for that specific time period.

In one or more embodiments, the transportation value modifier system 106 can provide for display a forecast scheduling element 432. In some cases, based on receiving a selection of the forecast scheduling element 432, the transportation value modifier system 106 can highlight one or more time periods from the plurality of time periods that correspond to one or more transportation value modifiers. For example, based on receiving a selection of the forecast scheduling element 432, the transportation value modifier system 106 can provide for display a second graphical user interface with one or more time periods that correspond to transportation value modifiers that are at least a 30% increase to the transportation service amount for a given week.

Additionally, in some implementations, the transportation value modifier system 106 can identify a transportation value modifier for a time period from the plurality of time periods 430 that exceeds a transportation value modifier threshold. In particular, the transportation value modifier system 106 can set the transportation value modifier threshold and identify one or more time periods from the plurality of time periods that correspond to the one or more transportation value modifiers that exceed the transportation value modifier threshold. In some cases, the transportation value modifier threshold corresponds to the highest transportation value modifier for a length of time (e.g., week) and/or a given day. For example, the transportation value modifier threshold can be 40% because that is the highest transportation value modifier for the plurality of time periods over a week. In one or more implementations, the transportation value modifier threshold can correspond to the top 3 transportation value modifiers for the length of time (e.g., week) and/or a given day.

As further shown in FIG. 4B, the transportation value modifier system 106 can provide for display on the provider device 422, a transportation value modifier notification 434 indicating which of the one or more time periods from the plurality of time periods exceeds the transportation value threshold. For example, as shown in FIG. 4B, the transportation value modifier system 106 can provide for display the modifier notification 434 indicating that the transportation value modifier 436 of 40% for the time period 438 from 10:00-11:00 PM meets or exceeds the transportation value modifier threshold. Indeed, the transportation value modifier system 106 can provide one or more notifications highlighting the highest transportation value modifier for a day, week, or month. In some cases, the transportation value modifier system 106 can detect the provider device closing the transportation matching system 104. In one or more embodiments, upon detecting closure of the transportation matching system 104, the transportation value modifier system 106 can provide for display an additional notification indicating that an upcoming time period corresponds to a high and/or valuable transportation value modifier. Additionally, in one or more implementations, the forecasted transportation value schedule 426 can correspond to a specific region or sub-region. For instance, in some cases, the provider devices provide transportation services in one or more regions or sub-regions. Accordingly, in some cases, the transportation value modifier system 106 can generate a plurality of forecasted transportation value schedules that correspond to a plurality of regions or sub-regions. For example, the transportation value modifier system 106 can generate a first forecasted transportation value schedule with a first plurality of transportation value modifiers for a first region and a second forecasted transportation value schedule with a second plurality of transportation value modifiers for a second region.

As discussed, the transportation value modifier system 106 can generate a plurality of transportation value modifiers for a plurality of time periods based on imbalances between provider devices and requestor devices. In some embodiments, the transportation value modifier system 106 can generate a plurality of sub-region transportation value modifiers for a plurality of sub-regions within a region. FIG. 4C shows the transportation value modifier system 106 determining a plurality of sub-region transportation value modifiers in accordance with one or more embodiments.

As discussed above, the transportation value modifier system 106 can determine an imbalance between provider devices and requestor devices for a plurality of time periods. In one or more embodiments, the transportation value modifier system 106 can determine imbalances between provider devices and requestor devices on a region-by-region and/or sub-region-by-sub-region basis. For example, the transportation value modifier system 106 can determine for a plurality of sub-regions 448a-c within a region, sub-region excess provider device imbalances. In particular, the transportation value modifier system 106 can determine which sub-regions are oversaturated or undersaturated with provider devices based on the transportation value modifier system 106 utilizing a region forecast model to generate a region (or sub-region) baseline forecast indicating the number of predicted provider devices and predicted requestor devices for the plurality of sub-regions 448a-c within the region. Moreover, as described above, the transportation value modifier system 106 can determine provider device elasticities for the plurality of sub-regions 448a-c within a region. Indeed, the transportation value modifier system 106 can utilize an optimization model to determine the plurality of sub-region transportation value modifiers 446a-c based on the sub-region excess provider device imbalances for the plurality of sub-regions 448a-c within the region.

As shown in FIG. 4C, the transportation value modifier system 106 can provide for display on the provider device 442, a forecasted sub-region transportation value schedule 444 comprising the plurality of sub-region transportation value modifiers 446a-c and the plurality of sub-regions 448a-c. As shown in FIG. 4C, the transportation value modifier system 106 can provide for display a sub-region transportation value notification 450 indicating that the provider device 442 is within or nearby a sub-region with a sub-region transportation value modifier. For example, the sub-region transportation value notification 450 can notify the provider device that they are navigating into a sub-region with a high and/or valuable sub-region transportation value modifier.

In one or more cases, the transportation value modifier system 106 can modify transportation service amounts on multiple different granularities. For example, the transportation value modifier system 106 can maintain a static sub-region transportation value modifier for a specific sub-region for an extended period of time. For example, a sub-region of downtown San Francisco can correspond to a static sub-region transportation value modifier of 10% for a month.

Moreover, in some embodiments, the transportation value modifier system 106 can further weigh trends or attributes of a specific sub-region while determining the sub-region transportation value modifier for the specific sub-region. For example, in some cases, the sub-region can correspond to a zone around an airport, train terminal, and/or arena. In an embodiment where the sub-region corresponds to a zone around the airport, the transportation value modifier system 106 can identify flight schedules, delays, and/or provider device utilization trends for transportation services and determine the sub-region transportation value modifier based on accounting for the flight schedules, delays, and/or provider device utilization trends.

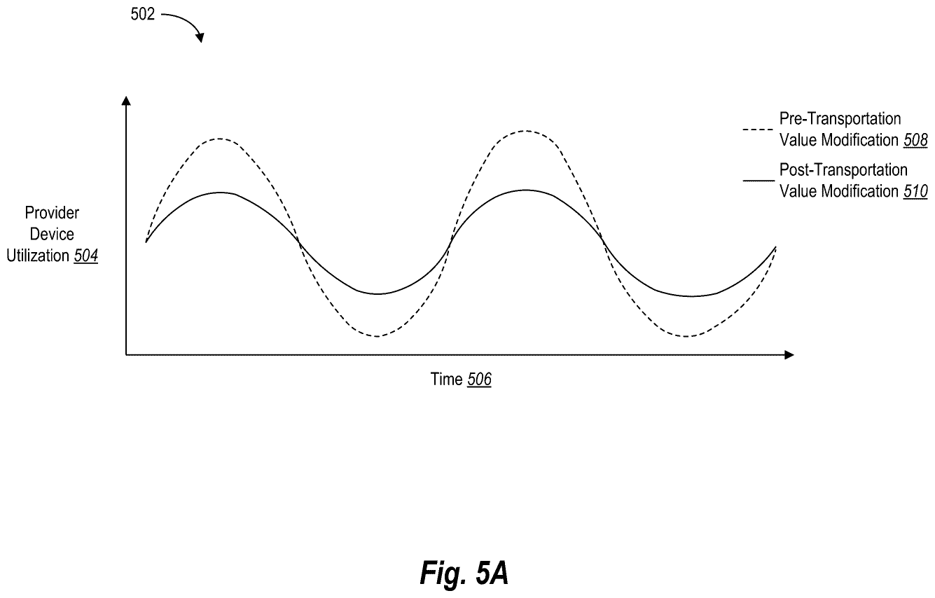

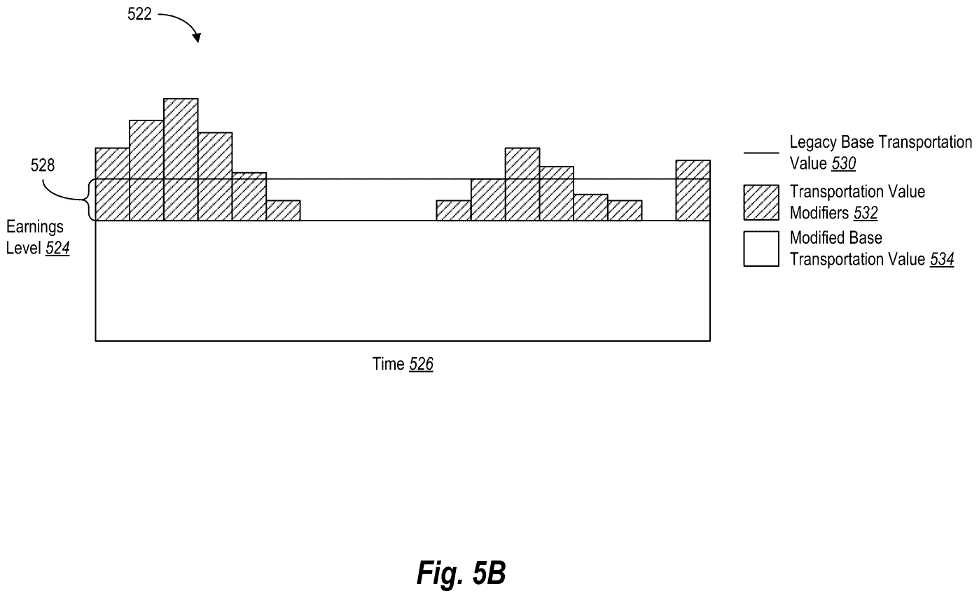

As indicated above, the transportation value modifier system 106 can dynamically, on a week-by-week basis, generate a forecasted transportation value schedule with a plurality of transportation value modifiers for a plurality of time periods by redistributing a consolidated transportation value to even out network imbalances. FIGS. 5A-5B illustrate the improved utilization by employing the transportation value modifier system and assigning a consolidated transportation value for a plurality of provider devices in accordance with one or more embodiments. In particular, FIG. 5A compares the utilization of provider devices before and after applying a plurality of transportation value modifiers for a plurality of time periods.

As shown in FIG. 5A, the utilization plot 502 depicts provider device utilization 504 across time 506. As indicated in FIG. 5A, in one or more embodiments, the provider device utilization 504 reflects the time spent traveling to and/or fulfilling a transportation request from a requestor device (e.g., compared to time spent waiting for a transportation match). As shown in FIG. 5A, the dashed line represents the provider device utilization 504 over the time 506 during pre-transportation value modification 508 (e.g., without applying the transportation value modifiers). Moreover, the solid line in the utilization plot 502 represents the provider device utilization 504 over the time 506 post-transportation value modification 510. As shown in FIG. 5A, the provider device utilization 504 over time 506 during the pre-transportation value modification 508 is more volatile than the provider device utilization 504 post-transportation value modification 510. By increasing the number of provider devices during high utilization times via the transportation value modifiers, the transportation value modifier system 106 decreases overall provider device utilization during these time periods. Moreover, during low provider device utilization times, by not applying the transportation value modifiers, the number of provider devices decreases and counter-intuitively increases overall provider device utilization during these time periods. For example, as described in more detail in FIG. 5B, the transportation value modifier system 106 decreases a legacy base transportation value during low provider device utilization times which reduces the incentive for provider devices to provide transportation services during the low provider device utilization times. By reducing the number of provider devices during the low provider device utilization times, the transportation value modifier system 106 reduces the time spent of provider devices waiting for a transportation match during the low provider device utilization times which counter-intuitively increases overall provider device utilization during such times. Indeed, the utilization plot 502 shows how the transportation value modifier system 106 can increase overall provider device utilization, decrease volatility in provider device utilization, decrease network imbalances between provider devices and requestor devices during a plurality of time periods, and provide a forecasted transportation value schedule that allows provider devices to identify and plan the best times to provide transportation services.

As just discussed, the transportation value modifier system 106 can improve network imbalance and provider device utilization via the transportation value modifiers. FIG. 5B shows a method for dynamically modifying transportation service values by funding the transportation value modifiers via a modification to a legacy base transportation value and transportation value modifiers (e.g., time-varying incentives) in accordance with one or more embodiments. In particular, FIG. 5B illustrates a dynamic transportation value modification plot 522 showing an earnings level 524 over time 526. As shown in the dynamic transportation value modification plot 522, the transportation value modifier system 106 can increase the earnings level 524 for time periods corresponding to peak transportation request hours by redistributing a consolidated transportation value 528. In particular, the transportation value modifier system 106 can set a modified base transportation value 534 that funds the transportation value modifiers 532. In some embodiments, the modified base transportation value 534 falls below the legacy base transportation value 530, where the difference corresponds to the consolidated transportation value 528. As discussed above and shown in the dynamic transportation value modification plot 522, the transportation value modifier system 106 can reassign the consolidated transportation value 528 to a plurality of provider devices via the transportation value modifiers 532.

Indeed, the transportation value modifier system 106 can change and/or update the modified base transportation value 534 and the consolidated transportation value 528 for different lengths of time (e.g., weeks). For example, based on the provider device elasticities, the transportation value modifier system 106 can raise the modified base transportation value 534 and adjust the consolidated transportation value 528 for a first week and decrease the modified base transportation value 534 and further change the consolidated transportation value 528 the second week. Indeed, the transportation value modifier system 106 can dynamically, on a week-by-week basis determine and change the modified base transportation value 534 and the consolidated transportation value 528 to proactively respond to changes in the number of provider devices, requestor devices, and experimental data related to the effectiveness of the transportation value modifiers over time and/or space (e.g., regions).

Moreover, in one or more embodiments, the transportation value modifier system 106 can implement the dynamic earnings method in provider device guidance tooling. For example, the transportation value modifier system 106 can generate an earnings summary showing how the transportation value modifiers increased earnings levels during certain time periods. Moreover, the transportation value modifier system 106 can project prospective earnings if the provider device initiates a transportation service during a time period corresponding to a transportation value modifier.

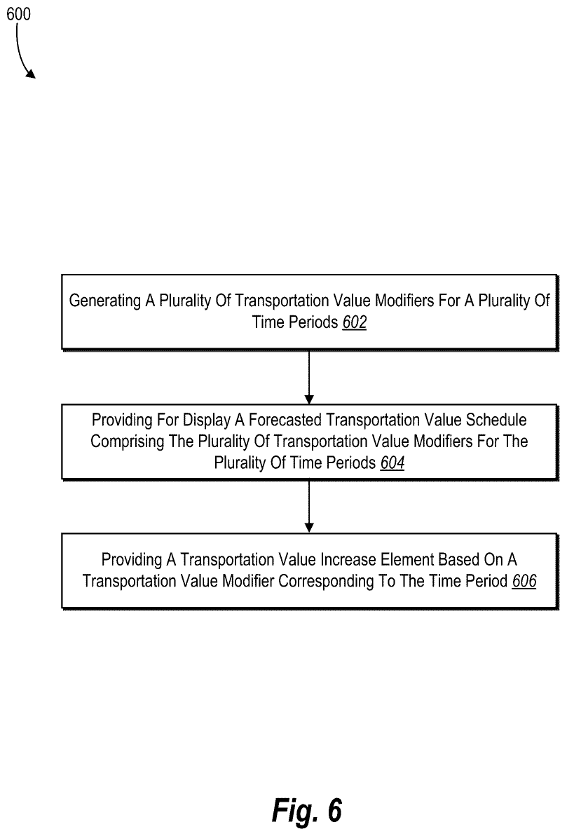

FIGS. 1-5B, the corresponding text, and the examples provide a number of different systems, methods, and non-transitory computer readable media for generating a plurality of transportation value modifiers for a plurality of time period and providing for display a forecasted transportation value schedule comprising the plurality of transportation value modifiers for the plurality of time periods. In addition to the foregoing, embodiments can also be described in terms of flowcharts comprising acts for accomplishing a particular result. For example, FIG. 6 illustrates a flowchart of an example sequence of acts in accordance with one or more embodiments.

While FIG. 6 illustrates acts according to some embodiments, alternative embodiments may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further embodiments, a system can perform the acts of FIG. 6. Additionally, the acts described herein may be repeated or performed in parallel with one another or in parallel with different instances of the same or other similar acts.

FIG. 6 illustrates an example series of acts 600 for generating a plurality of transportation value modifiers for a plurality of time periods. As shown, the series of acts 600 includes an act 602 of generating a plurality of transportation value modifiers for a plurality of time periods, an act 604 of providing for display a forecasted transportation value schedule comprising the plurality of transportation value modifiers for a plurality of time periods, and an act 606 of providing a transportation value increase element based on a transportation value modifier corresponding to the time period.

For example, in one or more implementations, the act 602 of the series of acts 600 includes generating, utilizing an optimization model, a plurality of transportation value modifiers for a plurality of time periods by assigning a consolidated transportation value for a plurality of provider devices based on predicted requestor devices, predicted provider devices, and a plurality of provider device elasticity metrics for the plurality of time periods. In some cases, the act 604 of the series of acts 600 includes providing for display on a provider device, a graphical user interface comprising a forecasted transportation value schedule comprising the plurality of transportation value modifiers and the plurality of time periods. Additionally, in one or more embodiments, the act 606 of the series of acts 600 includes in response to detecting initiation of a transportation service by the provider device during a time period of the plurality of time periods, providing a transportation value increase element for display to the provider device based on a transportation value modifier corresponding to the time period.

In one or more implementations, the series of acts 600 further includes utilizing the optimization model to determine a subset of transportation value modifiers for a subset of time periods to improve an objective of a number of transportation matches between provider devices and requestor devices for the plurality of time periods. Additionally, in some cases, the series of acts 600 includes an act where determining the provider device elasticity metrics further comprises utilizing a production function to generate a measure of change in transportation matches between requestor devices and provider devices relative to a change in transportation value. Further, in some embodiments, the series of acts 600 includes an act where providing for display on the provider device the graphical user interface comprising the forecasted transportation value schedule further comprises providing for display a first time period corresponding to a first transportation value modifier and a second time period corresponding to a second transportation value modifier.

Moreover, in one or more implementations, the series of acts 600 includes: updating, for an upcoming length of time, the plurality of transportation value modifiers for the plurality of time periods. In one or more embodiments, the series of acts 600 includes providing for display on the provider device for the upcoming length of time, an updated forecasted transportation value schedule comprising the updated plurality of transportation value modifiers for the plurality of time periods.

Also, in one or more implementations, the series of acts 600 includes locking in the transportation value modifier corresponding to the time period. Further, in some implementations, the series of acts 600 includes applying the transportation value modifier to a transportation service amount upon completion of the transportation service by the provider device.

In some cases, the series of acts 600 can include determining, for a plurality of sub-regions within a region, sub-region excess provider device imbalances. Additionally, in one or more implementations, the series of acts 600 includes determining for the plurality of sub-regions, a plurality of sub-region transportation value modifiers based on the sub-region excess provider device imbalances. Moreover, in one or more embodiments, the series of acts 600 includes providing for display on the provider device, a forecasted sub-region transportation value schedule comprising the plurality of sub-region transportation value modifiers and the plurality of sub-regions.

Furthermore, in one or more implementations, the series of acts 600 includes generating the consolidated transportation value by identifying a legacy base transportation value for the plurality of time period. In some implementations, the series of acts 600 includes selecting a modified base transportation value for the plurality of time periods. In one or more cases, the series of acts 600 includes generating the consolidated transportation value based on a difference between the legacy transportation value and the modified base transportation value.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 (e.g., the provider device(s) 108, the requestor device(s) 112, or the server(s) 102) that may be configured to perform one or more of the processes described above. One will appreciate that the transportation value modifier system 106 can comprise implementations of the computing device 700, including, but not limited to, the provider device(s) 108 and/or the server(s) 102. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output interface 708 (or “I/O interface 708”), which are provided to allow a user (e.g., requestor or provider) to provide input to (such as user strokes), receive output from, and otherwise transfer data to and from the computing device 700. The I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that connects components of computing device 700 to each other.

FIG. 8 illustrates an example network environment 800 of the transportation matching system 104. The network environment 800 includes a client device 806 (e.g., the provider device(s) 108 or the requestor device(s) 112), a transportation matching system 104, and a vehicle subsystem 808 connected to each other by a network 804. Although FIG. 8 illustrates a particular arrangement of the client device 806, the transportation matching system 104, the vehicle subsystem 808, and the network 804, this disclosure contemplates any suitable arrangement of client device 806, the transportation matching system 104, the vehicle subsystem 808, and the network 804. As an example, and not by way of limitation, two or more of client device 806, the transportation matching system 104, and the vehicle subsystem 808 communicate directly, bypassing network 804. As another example, two or more of client device 806, the transportation matching system 104, and the vehicle subsystem 808 may be physically or logically co-located with each other in whole or in part.

Moreover, although FIG. 8 illustrates a particular number of client devices 806, transportation matching systems 104, vehicle subsystems 808, and networks 804, this disclosure contemplates any suitable number of client devices 806, transportation matching system 104, vehicle subsystems 808, and networks 804. As an example, and not by way of limitation, network environment 800 may include multiple client devices 806, transportation matching systems 104, vehicle subsystems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, transportation value modifier system 106, and vehicle subsystem 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at the client device 806 to access network 804. A client device 806 may enable its user to communicate with other users at other client devices 806.

In particular embodiments, the client device 806 may include a requestor application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 104 may be a network-addressable computing system that can host a transportation matching network. The transportation matching system 104 may generate, store, receive, and send data, such as, for example, user-profile data, concept-profile data, text data, transportation request data, GPS location data, provider data, requestor data, vehicle data, or other suitable data related to the transportation matching network. This may include authenticating the identity of providers and/or vehicles who are authorized to provide transportation services through the transportation matching system 104. In addition, the transportation matching system 104 may manage identities of service requestors such as users/requestors. In particular, the transportation matching system 104 may maintain requestor data such as driving/riding histories, personal data, or other user data in addition to navigation and/or traffic management services or other location services (e.g., GPS services).

In particular embodiments, the transportation matching system 104 may manage transportation matching services to connect a user/requestor with a vehicle and/or provider. By managing the transportation matching services, the transportation matching system 104 can manage the distribution and allocation of resources from vehicle systems and user resources such as GPS location and availability indicators, as described herein.

The transportation matching system 104 may be accessed by the other components of network environment 800 either directly or via network 804. In particular embodiments, the transportation matching system 104 may include one or more servers. Each server may be a unitary server or a distributed server spanning multiple computers or multiple data centers. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or a transportation matching system 104 to manage, retrieve, modify, add, or delete, the information stored in data store.

In particular embodiments, the transportation matching system 104 may provide users with the ability to take actions on various types of items or objects, supported by the transportation matching system 104. As an example, and not by way of limitation, the items and objects may include transportation matching networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from transportation matching system 104 and coupled to the transportation matching system 104 via a network 804.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requestor profile) store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles for transportation providers and/or transportation requestors. A user profile may include, for example, biographic information, demographic information, behavioral information, social information, or other types of descriptive information, such as interests, affinities, or location.

The web server may include a mail server or other messaging functionality for receiving and routing messages between the transportation matching system 104 and one or more client devices 806. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties. Location stores may be used for storing location information received from client devices 806 associated with users.

In addition, the vehicle subsystem 808 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 808 can include an autonomous vehicle-e.g., a vehicle that does not require a human operator. In these embodiments, the vehicle subsystem 808 can perform maneuvers, communicate, and otherwise function without the aid of a human provider, in accordance with available technology.

In particular embodiments, the vehicle subsystem 808 may include one or more sensors incorporated therein or associated thereto. For example, sensor(s) can be mounted on the top of the vehicle subsystem 808 or else can be located within the interior of the vehicle subsystem 808. In certain embodiments, the sensor(s) can be located in multiple areas at once—e.g., split up throughout the vehicle subsystem 808 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 808 may include a communication device capable of communicating with the client device 806 and/or the transportation value modifier system 106. For example, the vehicle subsystem 808 can include an on-board computing device communicatively linked to the network 804 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
generating, utilizing an optimization model, a first plurality of transportation value modifiers for a first plurality of time periods associated with a first upcoming period of time and a second plurality of transportation value modifiers for a second plurality of time periods associated with a second upcoming period of time by assigning a consolidated transportation value for a plurality of provider devices based on predicted requestor devices, predicted provider devices, and a plurality of provider device elasticity metrics for the first plurality of time periods and the second plurality of time periods;
providing for display on a provider device, a graphical user interface comprising a forecasted transportation value schedule comprising a first selectable element corresponding to the first plurality of transportation value modifiers and the first plurality of time periods and a second selectable element corresponding to the second plurality of transportation value modifiers for a second plurality of time periods;
in response to detecting a selection of the first selectable element, providing for display on the graphical user interface of the provider device the first plurality of transportation value modifiers and the first plurality of time periods; and
in response to detecting initiation of a transportation service by the provider device during a time period of the first plurality of time periods, providing a transportation value increase element for display to the provider device based on a transportation value modifier corresponding to the time period.

2. The computer-implemented method of claim 1, wherein generating, utilizing the optimization model, the first plurality of transportation value modifiers further comprises:
utilizing the optimization model to determine a subset of transportation value modifiers for a subset of time periods to improve an objective of a number of transportation matches between provider devices and requestor devices for the first plurality of time periods.

3. The computer-implemented method of claim 1, wherein determining the plurality of provider device elasticity metrics further comprises:
determining the predicted provider devices based on a forecasting model utilizing linear quadratic estimation-to process historic provider device hours;
determining the predicted requestor devices corresponding to predicted requestor device intents based on the forecasting model processing historic requestor device data;
generating a baseline forecast based on the predicted provider devices and the predicted requestor devices; and
applying a customized production function to the baseline forecast to generate a measure of change in transportation matches between requestor devices and provider devices relative to a change in transportation value.

4. The computer-implemented method of claim 1, wherein providing for display on the provider device the graphical user interface comprising the forecasted transportation value schedule further comprises providing for display:
a first time period corresponding to a first transportation value modifier; and
a second time period corresponding to a second transportation value modifier.

5. The computer-implemented method of claim 1, further comprising:
updating, for an additional first upcoming period of time, the first plurality of transportation value modifiers for the first plurality of time periods; and
providing for display on the provider device for the additional first upcoming period of time, an updated forecasted transportation value schedule comprising the updated first plurality of transportation value modifiers for the first plurality of time periods.

6. The computer-implemented method of claim 1, further comprising:
locking in the transportation value modifier corresponding to the time period; and
applying the transportation value modifier to a transportation service amount upon completion of the transportation service by the provider device.

7. The computer-implemented method of claim 1, further comprising:
determining, for a plurality of sub-regions within a region, sub-region excess provider device imbalances;
determining for the plurality of sub-regions, a plurality of sub-region transportation value modifiers based on the sub-region excess provider device imbalances; and
providing for display on the provider device, a forecasted sub-region transportation value schedule comprising the plurality of sub-region transportation value modifiers and the plurality of sub-regions.

8. The computer-implemented method of claim 1, further comprising generating the consolidated transportation value by:
identifying a legacy base transportation value for the first plurality of time periods and the second plurality of time periods;
selecting a modified base transportation value for the first plurality of time periods and the second plurality of time periods; and
generating the consolidated transportation value based on a difference between the legacy base transportation value and the modified base transportation value.

9. A system comprising:
at least one processor; and
a non-transitory computer readable storage medium comprising instructions that, when executed by the at least one processor, cause the system to:
generate, utilizing an optimization model, a first plurality of transportation value modifiers for a first plurality of time periods associated with a first upcoming period of time and a second plurality of transportation value modifiers for a second plurality of time periods associated with a second upcoming period of time by assigning a consolidated transportation value for a plurality of provider devices based on predicted requestor devices, predicted provider devices, and a plurality of provider device elasticity metrics for the first plurality of time periods and the second plurality of time periods;
provide for display on a provider device, a graphical user interface comprising a forecasted transportation value schedule comprising a first selectable element corresponding to the first plurality of transportation value modifiers and the first plurality of time periods and a second selectable element corresponding to the second plurality of transportation value modifiers for a second plurality of time periods;
in response to detecting a selection of the first selectable element, provide for display on the graphical user interface of the provider device the first plurality of transportation value modifiers and the first plurality of time periods; and
in response to detecting initiation of a transportation service by the provider device during a time period of the first plurality of time periods, provide a transportation value increase element for display to the provider device based on a transportation value modifier corresponding to the time period.

10. The system of claim 9, wherein generating, utilizing the optimization model, the first plurality of transportation value modifiers and the second plurality of transportation value modifiers further comprises:
utilizing the optimization model to determine a subset of transportation value modifiers for a subset of time periods to improve an objective of a number of transportation matches between provider devices and requestor devices for the first plurality of time periods and the second plurality of time periods.

11. The system of claim 9, wherein determining the plurality of provider device elasticity metrics further comprises; utilizing a production function to generate a measure of change in transportation matches between requestor devices and provider devices relative to a change in transportation value.

12. The system of claim 9, wherein providing for display on the provider device the graphical user interface comprising the forecasted transportation value schedule further comprises providing for display:
a first time period corresponding to a first transportation value modifier; and
a second time period corresponding to a second transportation value modifier.

13. The system of claim 9, further comprising instructions that, when executed by the at least one processor, cause the system to:
update, for an additional first upcoming period of time, the first plurality of transportation value modifiers for the first plurality of time periods and for an additional second upcoming period of time, the second plurality of transportation value modifiers for the second plurality of time periods; and
provide for display on the provider device for the additional first upcoming period of time and the additional second upcoming period of time, an updated forecasted transportation value schedule comprising the updated first plurality of transportation value modifiers for the first plurality of time periods and the updated second plurality of transportation value modifiers for the second plurality of time periods.

14. The system of claim 9, further comprising instructions that, when executed by the at least one processor, cause the system to:
lock in the transportation value modifier corresponding to the time period; and
apply the transportation value modifier to a transportation service amount upon completion of the transportation service by the provider device.

15. A non-transitory computer readable storage medium comprising instructions that, when executed by at least one processor, cause the at least one processor to:
generate, utilizing an optimization model, a first plurality of transportation value modifiers for a first plurality of time periods associated with a first upcoming time period and a second plurality of transportation value modifiers for a second plurality of time periods associated with a second upcoming period of time by assigning a consolidated transportation value for a plurality of provider devices based on predicted requestor devices, predicted provider devices, and a plurality of provider device elasticity metrics for the first plurality of time periods and the second plurality of time periods;
provide for display on a provider device, a graphical user interface comprising a forecasted transportation value schedule comprising a first selectable element corresponding to the first plurality of transportation value modifiers and the first plurality of time periods and a second selectable element corresponding to the second plurality of transportation value modifiers for a second plurality of time periods;
in response to detecting a selection of the first selectable element, provide for display on the graphical user interface of the provider device the first plurality of transportation value modifiers and the first plurality of time periods; and
in response to detecting initiation of a transportation service by the provider device during a time period of the first plurality of time periods, provide a transportation value increase element for display to the provider device based on a transportation value modifier corresponding to the time period.

16. The non-transitory computer readable storage medium of claim 15, wherein generating, utilizing the optimization model, the second plurality of transportation value modifiers further comprises:
utilizing the optimization model to determine a subset of transportation value modifiers for a subset of time periods to improve an objective of a number of transportation matches between provider devices and requestor devices for the second plurality of time periods.

17. The non-transitory computer readable storage medium of claim 15, wherein determining the plurality of provider device elasticity metrics further comprises utilizing a production function to generate a measure of change in transportation matches between requestor devices and provider devices relative to a change in transportation value.

18. The non-transitory computer readable storage medium of claim 15, wherein providing for display on the provider device the graphical user interface comprising the forecasted transportation value schedule further comprises providing for display:
a first time period corresponding to a first transportation value modifier; and
a second time period corresponding to a second transportation value modifier.

19. The non-transitory computer readable storage medium of claim 15, further comprising instructions that, when executed by the at least one processor, cause the at least one processor to:
update, for an additional second upcoming period of time, the second plurality of transportation value modifiers for the second plurality of time periods; and
provide for display on the provider device for the additional second upcoming period of time, an updated forecasted transportation value schedule comprising the updated second plurality of transportation value modifiers for the second plurality of time periods.

20. The non-transitory computer readable storage medium of claim 15, further comprising instructions that, when executed by the at least one processor, cause the at least one processor to:
lock in the transportation value modifier corresponding to the time period; and
apply the transportation value modifier to a transportation service amount upon completion of the transportation service by the provider device.
